(19) United States
(12) Patent Application Publication
(10) Pub. No.: US 2025/0200712 A1
(43) Pub. Date: Jun. 19, 2025

(54) APPARATUS AND METHOD WITH IMAGE PROCESSING

(71) Applicant: Samsung Electronics Co., Ltd., Suwon-si (KR)

(72) Inventors: Yiwei CHEN, Beijing (CN); Jiaqian YU, Beijing (CN); Suengin PARK, Suwon-si (KR); Sangil JUNG, Suwon-si (KR); Siyang PAN, Beijing (CN); Wu BI, Beijing (CN); Byung In YOO, Suwon-si (KR); Qiang WANG, Beijing (CN)

(73) Assignee: Samsung Electronics Co., Ltd., Suwon-si (KR)

(21) Appl. No.: 18/969,694

(22) Filed: Dec. 5, 2024

(30) Foreign Application Priority Data
Dec. 13, 2023 (CN) 202311713806.0
Sep. 6, 2024 (KR) 10-2024-0121634

(51) Int. Cl. G06T 5/50; G06T 5/60; G06T 7/00

(52) U.S. Cl. CPC G06T 5/50; G06T 5/60; G06T 7/0002; G06T 2207/20084; G06T 2207/30168

(57) ABSTRACT

An apparatus with image processing includes one or more processors configured to generate a first transfer image corresponding to an input image by performing style transfer on the input image, using an image style transformer model, obtain transfer quality evaluation data on the first transfer image, using the image style transformer model, obtain a gradient for a style transfer loss, based on the transfer quality evaluation data, obtain update information on the first transfer image from an update information generation model to which the gradient is input, and generate a second transfer image by updating the first transfer image, based on the update information.

### CROSS-REFERENCE TO RELATED APPLICATIONS

This application claims the benefit under 35 USC § 119 (a) of Chinese Patent Application No. 202311713806.0, filed on Dec. 13, 2023, in the China National Intellectual Property Administration, and Korean Patent Application No. 10-2024-0121634, filed on Sep. 6, 2024, in the Korean Intellectual Property Office, the entire disclosures of which are incorporated herein by reference for all purposes.

### BACKGROUND

### 1. Field

The following description relates to an apparatus and method with image processing.

### 2. Description of Related Art

Image style transfer is a branch of image processing technology. Image style transfer may include transferring (e.g., transforming) a style of an image while preserving content (e.g., contents) of the image. Image style transfer technology may be applied in art creation, image editing, and the like. For example, image style transfer technology may give an image a unique style and effect by using a means for image processing and construction.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an apparatus with image processing includes one or more processors configured to generate a first transfer image corresponding to an input image by performing style transfer on the input image, using an image style transformer model, obtain transfer quality evaluation data on the first transfer image, using the image style transformer model, obtain a gradient for a style transfer loss, based on the transfer quality evaluation data, obtain update information on the first transfer image from an update information generation model to which the gradient is input, and generate a second transfer image by updating the first transfer image, based on the update information.

For the obtaining of the gradient, the one or more processors may be configured to obtain control data comprising image style transfer information, and obtain the gradient, based on the transfer quality evaluation data and the control data.

The one or more processors may be configured to obtain a first latent variable by encoding the input image, using the image style transformer model, for the generating of the first transfer image, generate the first transfer image by decoding the first latent variable, using the image style transformer model, obtaining a second latent variable by updating the first latent variable, based on the update information, and for the generating of the second transfer image, generate the second transfer image by decoding the second latent variable, using the image style transformer model.

The transfer quality evaluation data may include reliability of the first transfer image for the input image, for the obtaining of the gradient, the one or more processors may be configured to determine a style transfer loss, based on the transfer quality evaluation data and truth value data, and obtain the gradient, based on the determined style transfer loss, and the truth value data may include expected reliability for each pixel of the first transfer image.

The control data may include any one or any combination of any two or more of a direction of the style transfer, a degree of the style transfer, and a position of the style transfer.

In one or more general aspects, an apparatus with image processing includes one or more processors configured to generate a first transfer image corresponding to an input image by performing style transfer on the input image, using an image style transformer model, obtain control data comprising image style transfer information, obtain a gradient for a style transfer loss, based on the control data, and generate a second transfer image by updating the first transfer image, based on the gradient.

For the obtaining of the gradient, the one or more processors may be configured to adjust the style transfer loss, based on the control data, and obtain the gradient, based on the adjusted style transfer loss.

The image style transformer model may be a generative adversarial neural network, and for the obtaining of the gradient, the one or more processors may be configured to obtain transfer quality evaluation data of the first transfer image, using the generative adversarial neural network, and obtain the gradient, based on the transfer quality evaluation data and the control data.

For the obtaining of the gradient, the one or more processors may be configured to obtain a first gradient, based on the transfer quality evaluation data, obtain a second gradient, based on the control data, and obtain the gradient by fusing the first gradient and the second gradient.

The transfer quality evaluation data may include reliability data of the first transfer image for the input image, for the obtaining of the first gradient, the one or more processors may be configured to determine the style transfer loss, based on the transfer quality evaluation data and truth value data, and obtain the first gradient based on the determined style transfer loss, and the truth value data may include expected reliability data for each pixel of the first transfer image.

For the obtaining of the second gradient, the one or more processors may be configured to adjust the style transfer loss, based on the control data, and obtain the second gradient, based on the adjusted style transfer loss.

For adjusting of the style transfer loss, the one or more processors may be configured to adjust either one or both of the transfer quality evaluation data and the truth value data, based on the control data, and adjust the style transfer loss, based on the adjusted transfer quality evaluation data and the modified truth value data.

For the adjusting of the either one or both of the transfer quality evaluation data and the truth value data, the one or more processors may be configured to adjust the reliability data corresponding to one or more of pixels of the first transfer image, based on the control data, and adjust the truth value data corresponding to one or more of the pixels of the first transfer image, based on the control data.

For the obtaining of the gradient by fusing the first gradient and the second gradient, the one or more processors may be configured to obtain weight data for each of the first gradient and the second gradient, based on the control data, and obtain the gradient by fusing the first gradient and the second gradient, based on the weight data.

For the generating of the second transfer image, the one or more processors may be configured to obtain update information on the first transfer image from an update information generation model to which the gradient is input, and generate the second transfer image by updating the first transfer image, based on the update information.

The image style transformer model may be a generative adversarial neural network, and the one or more processors may be configured to obtain a first latent variable by encoding the input image, using the image style transformer model, for the generating of the first transfer image, generate the first transfer image by decoding the first latent variable, using the image style transformer model, obtain a second latent variable by updating the first latent variable, based on the update information, and for the generating of the second transfer image, generate the second transfer image by decoding the second latent variable, using the image style transformer model.

In one or more general aspects, a processor-implemented method with image processing includes generating a first transfer image corresponding to an input image by performing style transfer on the input image, using an image style transformer model, obtaining transfer quality evaluation data for the first transfer image, using the image style transformer model, obtaining a gradient for a style transfer loss, based on the transfer quality evaluation data, obtaining update information on the first transfer image from an update information generation model to which the gradient is input, and generating a second transfer image by updating the first transfer image, based on the update information.

The method may include obtaining control data comprising image style transfer information, wherein the obtaining of the gradient may include obtaining the gradient, based on the transfer quality evaluation data and the control data.

The generating of the first transfer image may include obtaining a first latent variable by encoding the input image, using the image style transformer model, and generating a first transfer image by decoding the first latent variable, using the image style transformer model, and the generating of the second transfer image may include obtaining a second latent variable by updating the first latent variable, based on the update information, and generating the second transfer image by decoding the second latent variable, using the image style transformer model.

In one or more general aspects, a processor-implemented method with image processing includes generating a first transfer image corresponding to an input image by performing style transfer on the input image, using an image style transformer model, obtaining control data comprising image style transfer information, obtaining a gradient for a style transfer loss, based on the control data, and generating a second transfer image by updating the first transfer image, based on the gradient.

Other features and aspects will be apparent from the following detailed description, the drawings, and the claims.

### BRIEF DESCRIPTION OF THE DRAWINGS

FIG. 1 illustrates an example of an overview of image style transfer technology.

FIG. 2 illustrates a flowchart of an example of operations of an image processing method.

FIG. 3 illustrates an example of an image processing process using transfer quality evaluation data.

FIG. 4 illustrates an example of image style transfer steps performed by an image processing apparatus.

FIG. 5 illustrates an example of an image style transfer image according to image style transfer steps.

FIG. 6 illustrates examples of image style transfer.

FIG. 7 illustrates a flowchart of an example of operations of an image processing method.

FIG. 8 illustrates an example of an image processing process using control data.

FIG. 9 illustrates an example of enhancing of a degree of image style transfer.

FIG. 10 illustrates an example of enhancing of a degree of image style transfer based on control data.

FIG. 11 illustrates an example of a reduction of a degree of image style transfer.

FIG. 12 illustrates an example of a reduction of a degree of image style transfer based on control data.

FIG. 13 illustrates an example of image style transfer using control data.

FIG. 14 illustrates an example of a gradient fusion operation.

FIG. 15 illustrates an example of generating a style transfer image based on a fusion gradient.

FIG. 16 illustrates an example of a gradient fusion operation.

FIG. 17 illustrates an example of image style transfer performed on a mobile terminal.

FIG. 18 illustrates a block diagram of an example of an image processing apparatus.

FIG. 19 illustrates a block diagram of an example of components of an image processing apparatus.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms used herein including technical and scientific terms have the same meanings as those commonly understood by one of ordinary skill in the art to which this disclosure pertains and based on an understanding of the disclosure of the present application. Terms such as those defined in commonly used dictionaries are to be interpreted as having a meaning that is consistent with their meaning in the context of the relevant art and the disclosure of the present application, and are not to be interpreted in an idealized or overly formal sense unless expressly so defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Hereinafter, the examples are described in detail with reference to the accompanying drawings. When describing the examples with reference to the accompanying drawings, like reference numerals refer to like components and a repeated description related thereto is omitted.

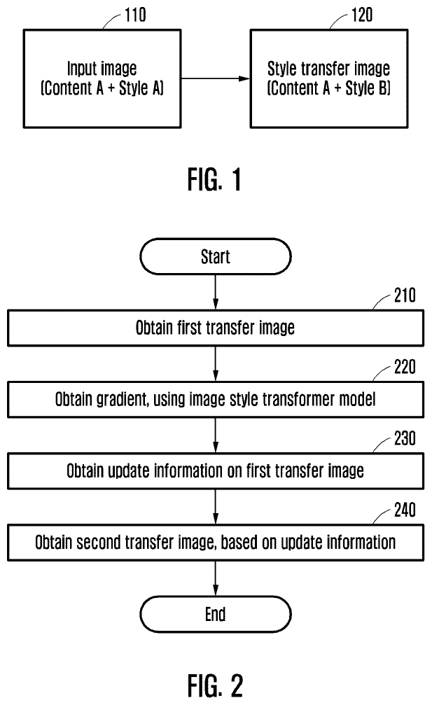

FIG. 1 illustrates an example of an overview of image style transfer technology.

Referring to FIG. 1, an input image 110 may consist of content and a style. The content may refer to a layout of an image, a relative position of an object in the image, and/or the like, and the style may refer to a color of the image, a texture of a line, a shape of the object, and/or the like.

Image style transfer may include generating a style transfer image 120 in which the style of the input image 110 is transferred while the content of the input image 110 is not transferred (e.g., is maintained or preserved). Image style transfer may separate the input image 110 into content A and a style A to transfer the style of the input image 110 from the style A to a style B, while preserving the content A of the input image 110. Image transfer technology may be used in fields such as art creation, image editing, and the like. For example, in the field of art creation, artists and designers may use image style transfer technology to change the style of a piece of work. In the field of image editing, a user may give a unique image effect to a photo by changing the style of the photo using image style transfer. In the field of film and game production, various visual atmospheres may be created by changing the style of a scene in a movie or a game, using image style transfer. In the field of virtual reality and augmented reality, a visual experience of a user of virtual reality and augmented reality may be improved and a virtual environment may be made more realistic or fantastic by using image style transfer in virtual reality and augmented reality applications.

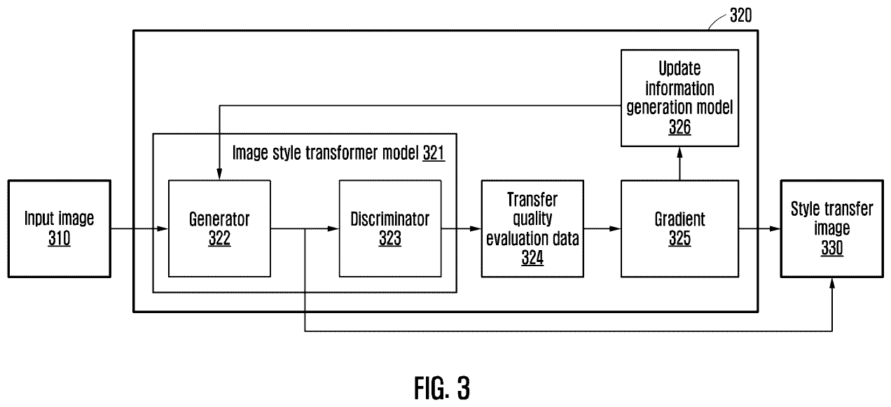

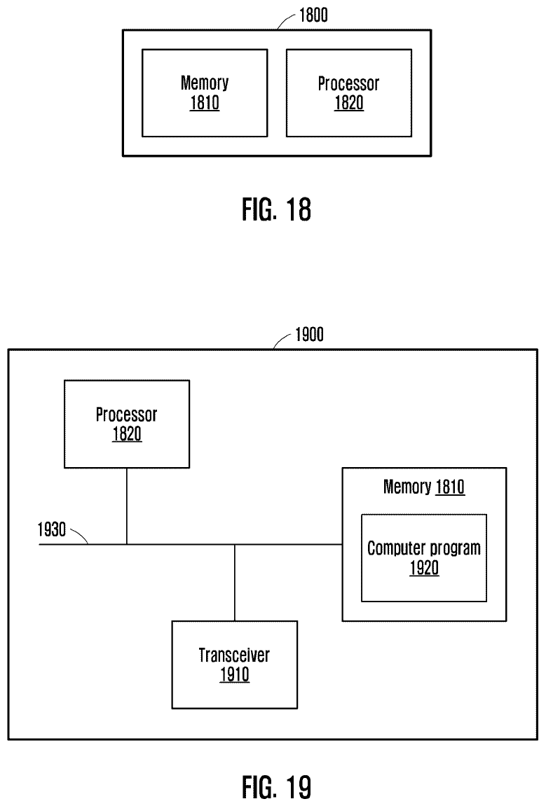

An apparatus with image processing may be referred to as an “image processing apparatus” herein. The image processing apparatus (e.g., an image processing apparatus 320 of FIG. 3, an image processing apparatus 1800 of FIG. 18, and/or an image processing apparatus 1900 of FIG. 19) may implement a unique style and effect to an input image as described above. For example, the input image 110 may be transferred from a sunny-day style to a cloudy-day style, a person in the input image 110 may be transferred from a no-makeup state to a made-up state, and/or a sheep in the input image 110 may be transferred to a giraffe.

The image processing apparatus of one or more embodiments may improve a quality of style transfer and a speed of style transfer and may enhance user experience in a style transfer process, using an image style transformer model (e.g., an image style transformer model 321 of FIG. 3) as described above.

FIG. 2 illustrates a flowchart of an example of operations of an image processing method. Operations 210 to 240 to be described hereinafter may be performed sequentially in the order and manner as shown and described below with reference to FIG. 2, but the order of one or more of the operations may be changed, one or more of the operations may be omitted, and two or more of the operations may be performed in parallel or simultaneously without departing from the spirit and scope of the example embodiments described herein.

Operations of the image processing method may be performed by an image processing apparatus (e.g., the image processing apparatus 320 of FIG. 3, the image processing apparatus 1800 of FIG. 18, and/or the image processing apparatus 1900 of FIG. 19).

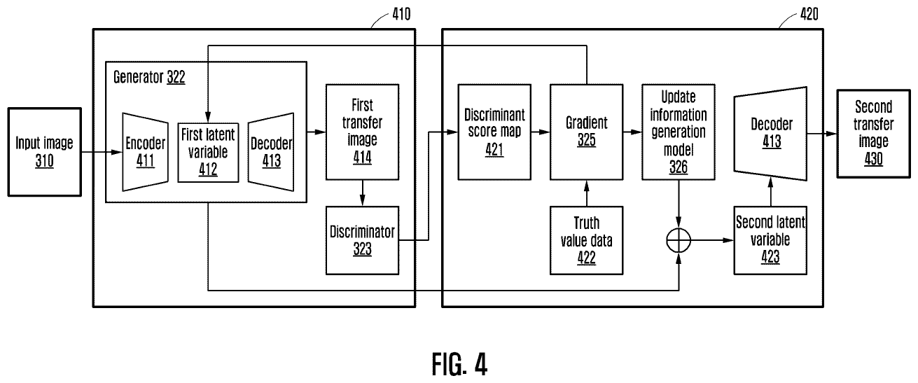

In operation 210, the image processing apparatus may obtain (e.g., generate) a first transfer image (e.g., a first transfer image 414 of FIG. 4). The image processing apparatus may obtain the first transfer image corresponding to an input image by performing style transfer on an input image (e.g., an input image 310 of FIG. 3), using an image style transformer model (e.g., the image style transformer model 321 of FIG. 3). For example, the image processing apparatus may perform style transfer on the input image, using a generative adversarial neural network included in the image style transformer model, to obtain the first transfer image. The generative adversarial neural network may be a generative adversarial network (GAN) and/or a variation of a GAN and may include a generator (e.g., a generator 322 of FIG. 3) and a discriminator (e.g., a discriminator 323 of FIG. 3). An example of the generative adversarial neural network is described in more detail with reference to FIG. 3.

In operation 220, the image processing apparatus may obtain (e.g., determine) a gradient (e.g., a gradient 325 of FIG. 3), using the image style transformer model. For example, the image processing apparatus may obtain transfer quality evaluation data (e.g., transfer quality evaluation data 324 of FIG. 3) for the first transfer image based on the first transfer image, using the image style transformer model, and may obtain a gradient for a style transfer loss, based on the transfer quality evaluation data. The image processing apparatus may obtain the transfer quality evaluation data obtained by evaluating transfer quality of the first transfer image, using the discriminator of the generative adversarial neural network, and may obtain the gradient related to the style transfer loss, based on the transfer quality evaluation data. The image processing apparatus may generate a high-quality transfer image using the transfer quality evaluation data.

In operation 230, the image processing apparatus may obtain update information on the first transfer image.

The image processing apparatus may obtain the update information on the first transfer image from an update information generation model (e.g., an update information generation model 326 of FIG. 3) to which the gradient is input. The image processing apparatus may obtain the update information on the first transfer image that is based on the gradient, using an artificial intelligence (AI) network included in the update information generation model. The update information may be used for mining of the first transfer image by the image processing apparatus.

In operation 240, the image processing apparatus may obtain a second transfer image, based on the update information. For example, the image processing apparatus may obtain the second transfer image by updating the first transfer image by mining information included in the gradient. The image processing apparatus of one or more embodiments may improve a quality of image style transfer by updating the first transfer image. The image processing apparatus of one or more embodiments may improve an update speed of a first transfer image by using a mining-based update method that does not involve an optimization task.

FIG. 3 illustrates an example of an image processing process using transfer quality evaluation data.

Referring to FIG. 3, the image processing apparatus 320 may include an image style transformer model 321 and an update information generation model 326. The image style transformer model 321 may include the generator 322 and the discriminator 323. The image style transformer model 321 may be a variant model of a generative adversarial neural network and/or a GAN. The generator 322 included in a generative adversarial neural network may be optimized by performing adversarial training and may generate a first transfer image (e.g., a first transfer image 414 of FIG. 4) for the input image 310, based on the input image 310. The discriminator 323 may be used to evaluate authenticity of a transfer image generated by the generator 322. The generator 322 may generate, based on feedback from the discriminator 323, a transfer image that may deceive the discriminator 323, and the discriminator 323 may train the image style transformer model 321 through a process of distinguishing between a training image and the transfer image generated by the generator 322.

The input image 310 may be input to the image style transformer model 321. The image processing apparatus 320 may obtain the transfer quality evaluation data 324 from the image style transformer model 321. The image style transformer model 321 may be a generative adversarial neural network including the generator 322 and the discriminator 323. The image style transformer model 321 may generate the first transfer image by transferring (e.g., transforming) the input image 310, using the generator 322. The first transfer image may be a transfer image obtained by roughly transferring the input image 310. The image processing apparatus 320 of one or more embodiments may not only perform image transfer on the input image 310 by using the generator 322 of the image style transformer model 321, but also update, by using the discriminator 323, the first transfer image generated by the generator 322 and may thus obtain a final transfer image (e.g., a style transfer image 330) with a higher quality. For example, when the input image 310 is input to the generator 322 of the image style transformer model 321, the generator 322 may generate the first transfer image. The generated first transfer image may be input to the discriminator 323, and the discriminator 323 may output the transfer quality evaluation data 324 for the first transfer image (e.g., determination information on being true or false). The image processing apparatus 320 may obtain the gradient 325 related to a style transfer loss, based on the transfer quality evaluation data 324. The gradient 325 may include information on a position in the first transfer image on which a correction or an update is to be performed. The update information generation model 326 to which the gradient 325 is input may output update information for the first transfer image. The generator 322 may generate the final transfer image (e.g., a second transfer image or the style transfer image 330) by updating the first transfer image based on the output update information. As described above, the image processing apparatus 320 may generate the style transfer image 330 through a two-step image transfer process for the input image 310. The image processing apparatus 320 of one or more embodiments may generate the second transfer image with a higher quality by generating the first transfer image through a first-step style transfer and subsequently updating the first transfer image through a second-step style transfer.

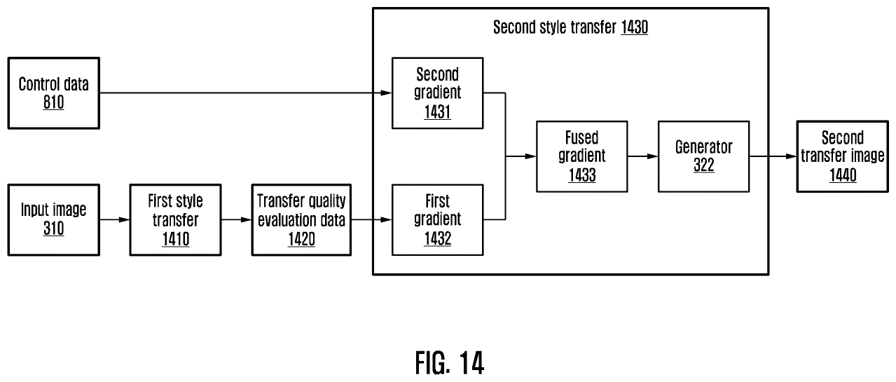

The image processing apparatus may obtain control data including image style transfer information, and may obtain the gradient, based on the transfer quality evaluation data and the control data. An example of obtaining the gradient based on the transfer quality evaluation data and the control data, performed by the image processing apparatus, is described in more detail with reference to FIG. 14.

FIG. 4 illustrates an example of image style transfer steps performed by an image processing apparatus.

Referring to FIG. 4, the image processing apparatus (e.g., the image processing apparatus 320 of FIG. 3, the image processing apparatus 1800 of FIG. 18, and/or the image processing apparatus 1900 of FIG. 19) may generate a second transfer image 430 through first-step image style transfer 410 and second-step image style transfer 420.

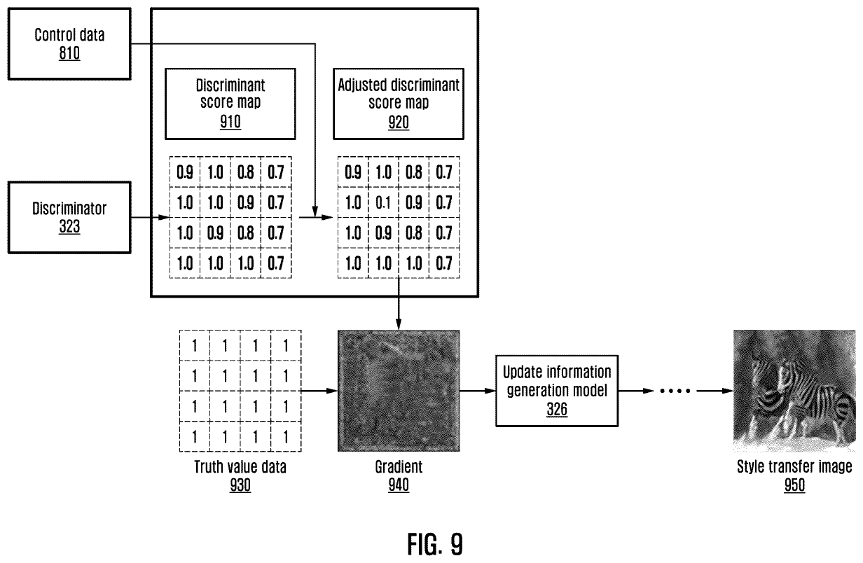

In the first-step image style transfer 410, the image processing apparatus may obtain a first latent variable 412 by encoding, using an encoder 411, the input image 310. The first latent variable 412 may represent a feature of an encoded image of the input image 310. The image processing apparatus may obtain a first transfer image 414 by decoding, using a decoder 413 of an image style transformer model, the first latent variable 412. The image processing apparatus may obtain transfer quality evaluation data for the first transfer image 414 from the discriminator 323 to which the first transfer image 414 is input. The transfer quality evaluation data may include reliability information of the first transfer image 414 (e.g., determination information on whether the first transfer image 414 is true or false) compared to the input image 310. The transfer quality evaluation data may include reliability data corresponding to each pixel of the first transfer image 414. For example, the transfer quality evaluation data may be a discriminant score map 421 (e.g., a discriminant score map 910 of FIG. 9) output by the discriminator, and each numeric value of the discriminant score map may represent a reliability level corresponding to a pixel at a corresponding position. A low value in the discriminant score map may indicate a low reliability level of the pixel at the corresponding position, and a high value in the discriminant score map may indicate a high reliability level of the pixel at the corresponding position. The discriminator may be or include, but is not limited to, one or more fully convolutional networks (FCNs).

In the second-step image style transfer 420, the image processing apparatus may obtain a second latent variable 423 by updating, based on update information, the first latent variable 412, and may obtain the second transfer image 430 by decoding, using the decoder 413 of the image style transformer model, the second latent variable 423.

The image processing apparatus may obtain the gradient 325, based on the discriminant score map 421 and truth value data 422. For example, a style transfer loss may be determined based on transfer quality evaluation data and the truth value data 422, and the gradient 325 may be obtained based on the determined style transfer loss. The transfer quality evaluation data may include the discriminant score map 421 output by the discriminator 323 and reliability of the first transfer image 414 for the input image 310. The truth value data 422 may include reliability data for each pixel of the first transfer image 414. For example, a map of the truth value data 422 (e.g., ground truth (GT)) may have a same size as the discriminant score map 421, and values at positions corresponding to each pixel of the first transfer image 414 may all be “1.” The truth value data 422 having each pixel value of “1” may indicate that expected reliability for each pixel is 1. An example of an operation of obtaining the gradient 325 by the image processing apparatus based on the discriminant score map 421 and the truth value data 422 is described in more detail with reference to FIG. 9.

To obtain the gradient 325, the image processing apparatus may determine a style transfer loss, based on the discriminant score map 421 and the truth value data 422. For example, the image processing apparatus may determine the style transfer loss using a mean squared error (MSE) loss function. The MSE loss function may have a greater gradient as the loss increases and have a lesser gradient as the loss decreases. The image processing apparatus may determine an MSE loss determined through the above-described process to be the style transfer loss.

The image processing apparatus may obtain the gradient 325 by performing a single back-propagation based on the style transfer loss. For example, the gradient 325 may be obtained by performing a single back-propagation through Equation 1 below.

$${G}_{A} = \frac{\partial {\vert {DM}_{A} - GT \vert}_{2}^{2}}{\partial {L}_{0}} \qquad Equation 1$$

In Equation 1, G_{A} denotes the gradient 325, DM_{A} denotes the discriminant score map 421 output from the discriminator, GT denotes the truth value data 422, |DM_{A}−GT|₂² denotes the style transfer loss, and L₀ denotes the first latent variable 412. The image processing apparatus may obtain update information on the first transfer image 414 from the update information generation model 326 to which the obtained gradient 325 is input.

The image processing apparatus may obtain the second latent variable 423 by updating, based on the update information, the first latent variable 412, and may obtain the second transfer image 430 by decoding, using the decoder 413, the second latent variable 423. The second latent variable 423 may be expressed as in Equation 2 below, for example.

$${L}_{1} = {L}_{0} + ⋃ ( {G}_{A} ) \qquad Equation 2$$

In Equation 2, G_{A} denotes the gradient 325, U denotes the update information generation model 326, U(G_{A}) denotes update information of the first latent variable 412 L₀, obtained by mining information included in the gradient G_{A}, and L₁ denotes the second latent variable 423 obtained by updating the first latent variable 412 L₀, based on U(G_{A}). The image processing apparatus may obtain the second transfer image 430 by decoding the second latent variable 423 L₁, using the decoder 413 of the generator 322.

As described above, the image processing apparatus may update the first transfer image 414 by mining information included in the gradient obtained from the discriminator and the update information generation model. The image processing apparatus of one or more embodiments may improve transfer quality of a style transfer image through the above process. In addition, since the image processing apparatus may use the update information generation model to obtain the update information instead of directly utilizing the gradient to perform an optimization task in the process of updating the first transfer image, the image processing apparatus of one or more embodiments may improve a speed of the image transfer processing.

The image processing apparatus of one or more embodiments may perform image processing based on control data to improve user experience. Control data may refer to data that a user may use to control the gradient related to the style transfer loss. The image processing of one or more embodiments based on control data may improve the user experience by allowing a user control on an image style transfer process and thus obtaining a transfer image that satisfies the user.

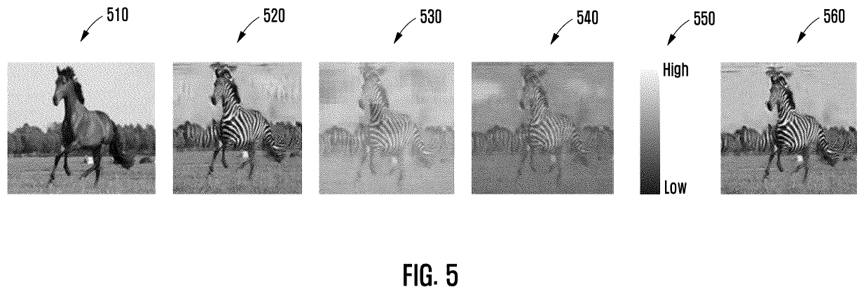

FIG. 5 illustrates an example of an image style transfer image according to image style transfer steps.

Referring to FIG. 5, an image 510 may represent an input image, an image 520 may represent a first transfer image, an image 530 may represent a discriminant score map, an image 540 may represent a gradient visualization map, and an image 560 may represent a second transfer image. An image 550 may represent high and low reliability for each pixel.

The image 520 may be the first transfer image that is output after a first-step style transfer process is performed on the input image and may include some unrealistic areas such as an area with an artificially generated trace.

The image 530 may be the discriminant score map, which may be used to evaluate reliability of the first transfer image. The discriminant score map may include information on a style transfer quality of each pixel in the first transfer image, and a pixel with a low value may indicate that the reliability of the pixel at a corresponding position is low.

The image 540 may be the gradient visualization map, which may be used to improve a quality of image style transfer. An area with a high value in the gradient visualization map may correspond to a position in which an artificially generated trace exists in the first transfer image of the image 520. The area with the high value in the gradient visualization map may indicate that the gradient includes information that may be used to improve the quality of image style transfer. As described above, since the gradient indicates a position of an area, in the first transfer image, which is to be modified or updated, the gradient may be used as the update information for image style transfer.

The image 560 may represent the second transfer image obtained by performing a second-step image style transfer based on the gradient. By the performing of the second-step image style transfer, the second transfer image may have an artificial area of the first transfer image (e.g., the image 520) removed, and the image processing apparatus of one or more embodiments may improve a quality of the second transfer image.

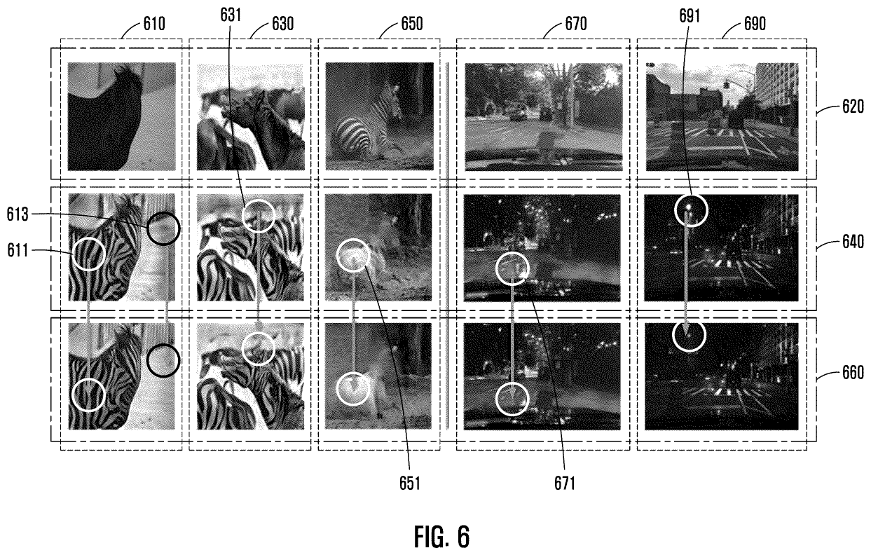

FIG. 6 illustrates examples of image style transfer.

Referring to FIG. 6, an image processing apparatus (e.g., the image processing apparatus 320 of FIG. 3, the image processing apparatus 1800 of FIG. 18, and/or the image processing apparatus 1900 of FIG. 19) may generate first transfer images 640 by transferring input images 620 and may generate second transfer images 660 by updating the first transfer images 640. An image set (e.g., an image set 610) may include an input image, a first transfer image, and a second transfer image. A display area of the first transfer image and a display area of the second transfer image corresponding to the first transfer image may represent a same area. For example, an area 611 of the first transfer image included in the image set 610 may represent the same area as an area displayed in the second transfer image corresponding to the first transfer image.

The first transfer images 640 obtained by performing image style transfer on the input images 620 may include an artificial or unnatural portion. For example, the area 611 and an area 613 of the first transfer image of the image set 610, an area 631 of a first transfer image of an image set 630, an area 651 of a first transfer image of an image set 650, an area 671 of a first transfer image of an image set 670, and an area 691 of a first transfer image of an image set 690 may represent unnatural areas in the first transfer images due to image transfer.

By updating the first transfer image, the image processing apparatus of one or more embodiments may improve an artificial part of the first transfer image and may obtain a more realistic second transfer image. For example, by updating the first transfer images, areas of a second transfer image corresponding to the area 611 and the area 613 of the first transfer image of the image set 610, an area of a second transfer image corresponding to the area 631 of the first transfer image of the image set 630, an area of a second transfer image corresponding to the area 651 of the first transfer image of the image set 650, an area of a second transfer image corresponding to the area 671 of the first transfer image of the image set 670, and an area of a second transfer image corresponding to the area 691 of the first transfer image of the image set 690 may become more natural and realistic.

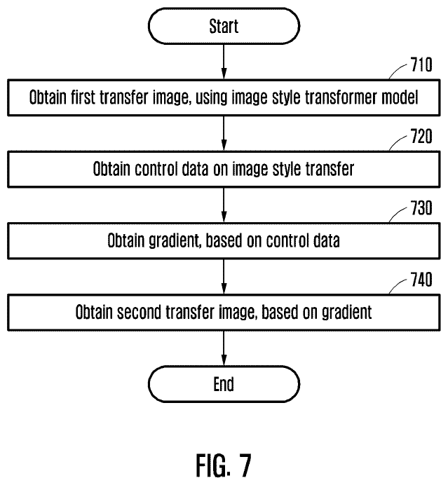

FIG. 7 illustrates a flowchart of an example of operations of an image processing method. Operations 710 to 740 to be described hereinafter may be performed sequentially in the order and manner as shown and described below with reference to FIG. 7, but the order of one or more of the operations may be changed, one or more of the operations may be omitted, and two or more of the operations may be performed in parallel or simultaneously without departing from the spirit and scope of the example embodiments described herein.

Operations of the image processing method may be performed by an image processing apparatus (e.g., the image processing apparatus 320 of FIG. 3, the image processing apparatus 1800 of FIG. 18, and/or the image processing apparatus 1900 of FIG. 19).

In operation 710, the image processing apparatus may obtain a first transfer image corresponding to an input image, using an image style transformer model (e.g., the image style transformer model 321 of FIG. 3). The image style transformer model may be a generative adversarial neural network and may include a model trained for image style transfer. The image processing apparatus may include a generator (e.g., the generator 322 of FIG. 3), and the generator may include an encoder (e.g., the encoder 411 of FIG. 4) and a decoder (e.g., the decoder 413 of FIG. 4). The image processing apparatus may obtain a first latent variable (e.g., the first latent variable 412 of FIG. 4) by encoding, using the image style transformer model, the input image, and may obtain a first transfer image (e.g., the first transfer image 414 of FIG. 4) by decoding the first latent variable. Since an example of the image style transformer model is described in detail with reference to FIG. 2, a repeated description thereof is omitted herein.

In operation 720, the image processing apparatus may obtain control data including image style transfer information. The control data may include at least one of a direction of style transfer, a degree of the style transfer, and/or a position of the style transfer. The method of obtaining control data may not be limited, and control data may be input through a touch operation on a user interface.

In operation 730, the image processing apparatus may obtain a gradient for a style transfer loss, based on the control data. The image processing apparatus may adjust the style transfer loss, based on the control data, and may obtain the gradient, based on the adjusted style transfer loss. The image style transformer model may be a generative adversarial neural network, and the image processing apparatus may obtain transfer quality evaluation data by using a discriminator of the adversarial network, and may determine the style transfer loss, based on the transfer quality evaluation data and truth value data.

The image processing apparatus may adjust the transfer quality evaluation data and the truth value data, based on the control data, and may adjust the style transfer loss, based on the adjusted transfer quality evaluation data or the modified truth value data. For example, the image processing apparatus may adjust the transfer quality evaluation data, based on the control data, and may adjust the style transfer loss, based on the adjusted transfer quality evaluation data and the unmodified truth value data. Alternatively, the image processing apparatus may adjust the truth value data based on the control data, and may obtain an adjusted style transfer loss, based on the unadjusted transfer quality evaluation data and the modified truth value data. The image processing apparatus may adjust both the transfer quality evaluation data and the truth value data, and may adjust the style transfer loss, based on the adjusted transfer quality evaluation data and the modified truth value data.

The image processing apparatus may obtain the gradient, based on the adjusted style transfer loss. Since an example of the obtaining of the gradient based on the style transfer loss is described with reference to FIG. 4, a repeated description thereof is omitted herein.

In operation 740, the image processing apparatus may obtain a second transfer image, based on the gradient. The image processing apparatus may obtain update information on the first transfer image from an update information generation model to which the gradient is input and may obtain the second transfer image by updating, based on the update information, the first transfer image. For example, when the update information generation model is a generative adversarial neural network, the image processing apparatus may obtain a second latent variable by updating the first latent variable based on the update information and may obtain the second transfer image by decoding the second latent variable.

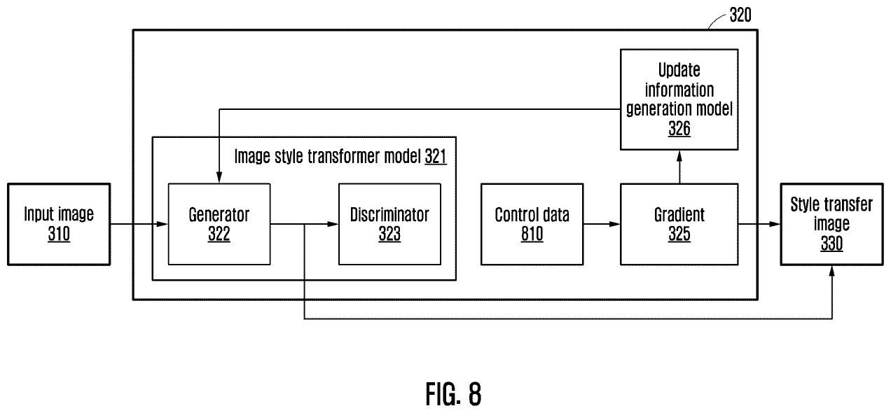

FIG. 8 illustrates an example of an image processing process using control data.

Referring to FIG. 8, the image processing apparatus 320 may include the image style transformer model 321 and the update information generation model 326. The image style transformer model 321 may include the generator 322 and the discriminator 323. Since examples of the input image 310, the image style transformer model 321, the update information generation model 326, the generator 322, the discriminator 323, and the style transfer image 330 are described with reference to FIG. 3, a repeated description thereof is omitted herein. The image processing apparatus may adjust the style transfer loss, based on the control data, and may obtain the gradient, based on the adjusted style transfer loss. The image processing apparatus may adjust the style transfer loss by adjusting a discriminant score map. For example, when the image processing apparatus determines the style transfer loss using an MSE loss function, the discriminant score map may be adjusted based on the control data of a user, and an MSE loss may be adjusted based on truth value data and the adjusted discriminant score map. The image processing apparatus may determine the MSE loss adjusted through the above-described process to be the adjusted style transfer loss.

Examples of adjusting the style transfer loss based on the control data and obtaining the style transfer image based on the adjusted style transfer loss, performed by the image processing apparatus, are described in more detail with reference to FIGS. 9 to 12.

FIG. 9 illustrates an example of enhancing of a degree of image style transfer.

Referring to FIG. 9, the image processing apparatus may obtain a style transfer image 950, based on control data 810 and truth value data 930. The image processing apparatus may obtain an adjusted discriminant score map 920 by adjusting, based on the control data 810, the discriminant score map 910 obtained from the discriminator 323. The adjusted discriminant score map 920 may include a pixel, among pixels of the discriminant score map 910, of which an expected value has been adjusted downward (e.g., decreased).

The image processing apparatus may obtain a gradient 940, based on the control data 810 and transfer quality evaluation data obtained from the discriminator 323. The transfer quality evaluation data may be the discriminant score map 910.

The image processing apparatus may obtain the adjusted discriminant score map 920 by adjusting, using the control data 810, the discriminant score map 910. For example, the image processing apparatus may adjust a value at a specific position of the discriminant score map 910 to a value of the control data 810, to obtain the adjusted discriminant score map 920. The image processing apparatus may obtain the gradient 940, based on the truth value data 930 and the adjusted discriminant score map 920. For example, the image processing apparatus may obtain an adjusted style transfer loss, based on the truth value data 930 and the adjusted discriminant score map 920, and may obtain the gradient 940 by performing a single back-propagation. The gradient may be expressed as in Equation 3 below, for example.

$${G}_{B} = \frac{\partial {\vert {DM}_{B} - GT \vert}_{2}^{2}}{\partial {L}_{0}} \qquad Equation 3$$

In Equation 3, G_{B} denotes the gradient 940, DM_{B} denotes an adjusted discriminant score map obtained by adjusting, based on the control data, a discriminant score map, GT denotes truth value data, |DM_{B}−GT|₂² denotes an adjusted style transfer loss, and L₀ denotes a first latent variable.

The image processing apparatus may of one or more embodiments enhance a degree of style transfer of a specific area by using a gradient that is based on the adjusted style transfer loss. For example, when reliability at a specific position in the discriminant score map 910 is adjusted downward from 1.0 to 0.1, the style transfer loss at that specific position may increase. When the style transfer loss is positively correlated with the gradient, the gradient at a specific position may increase.

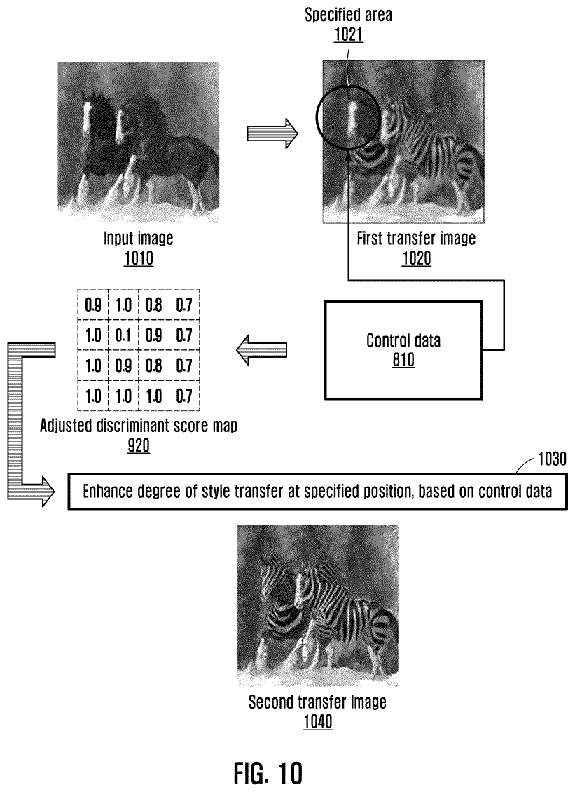

The image processing apparatus may obtain update information from the update information generation model 326, based on the gradient 940 which has increased, and obtain the style transfer image 950 (e.g., a second transfer image (e.g., the second transfer image 430 of FIG. 4)) by updating, using the obtained update information, the first transfer image. An example of obtaining the style transfer image 950 with an enhanced degree of image style transfer based on the control data 810, performed by the image processing apparatus, is described in more detail with reference to FIG. 10.

FIG. 10 illustrates an example of enhancing of a degree of image style transfer based on control data.

Referring to FIG. 10, the image processing apparatus may obtain a second transfer image 1040 by performing, based on the control data 810, image style transfer on an input image 1010. The second transfer image 1040 may correspond to the style transfer image 950 of FIG. 9.

The image processing apparatus may enhance a degree of style transfer of an area specified by a user (e.g., a specified area 1021) in a first transfer image 1020 obtained by performing, based on the control data 810, image style transfer on the input image 1010. For example, the image processing apparatus may obtain the adjusted discriminant score map 920 by adjusting the discriminant score map 910 based on the control data 810 (e.g., adjusting reliability of the specified area 1021 from 1.0 to 0.1). The image processing apparatus may enhance the degree of style transfer of the specified area 1021, based on the adjusted discriminant score map 920.

The image processing apparatus may increase a gradient by increasing a style transfer loss of the specified area 1021 and enhance a degree of image style transfer of a pixel. Through the above-described process, the image processing apparatus may obtain the second transfer image 1040, by performing operation 1030 of enhancing the degree of style transfer at a specified position based on the control data 810.

The image processing apparatus may enhance the degree of image style transfer of the specified area 1021 by adjusting, based on control data 810, truth value data of a pixel corresponding to the specified area 1021. For example, the style transfer loss may be adjusted to increase by increasing a truth value of the pixel corresponding to the specified area 1021 in the truth value data. The image processing apparatus may increase the gradient, based on an increased style transfer loss, and enhance the degree of image style transfer of the specified area 1021, based on the increased gradient.

The image processing apparatus may increase the style transfer loss by adjusting the truth value data and the discriminant score map of the pixel corresponding to the specified area 1021 and may enhance a degree of style transfer of the pixel corresponding to the specified area 1021 by increasing the gradient based on the increased style transfer loss.

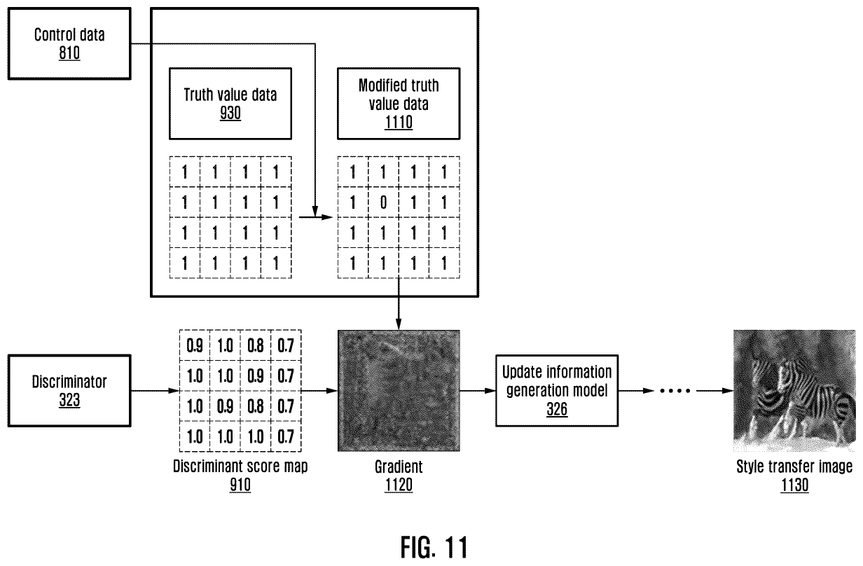

FIG. 11 illustrates an example of a reduction of a degree of image style transfer.

Referring to FIG. 11, the image processing apparatus may obtain a gradient 1120 based on modified truth value data 1110 and the discriminant score map 910, and obtain a style transfer image 1130 with a reduced degree of image style transfer, based on the gradient 1120.

The image processing apparatus may reduce the degree of style transfer for a specific position of an input image by modifying, based on the control data 810, the truth value data 930. For example, the image processing apparatus may obtain the modified truth value data 1110 by modifying, according to the control data 810, a value of a pixel corresponding to a specific position in a map of the truth value data 930 having a same size in the discriminant score map 910. The image processing apparatus may obtain a modified style transfer loss, based on the modified truth value data 1110 and the discriminant score map 910. The image processing apparatus may obtain the gradient 1120, based on the modified style transfer loss. The image processing apparatus may obtain the gradient 1120 by performing, based on Equation 4 below, for example, a single back-propagation.

$${G}_{B} = \frac{\partial {\vert {DM}_{A} - {GT}_{B} \vert}_{2}^{2}}{\partial {L}_{0}} \qquad Equation 4$$

In Equation 4, G_{B} denotes the gradient 1120, DM_{A} denotes the discriminant score map 910 obtained from the discriminator 323, GT_{B} denotes the modified truth value data 1110 obtained by modifying the truth value data 930 based on the control data 810, |DM_{A}−GT_{B}|₂² denotes the modified style transfer loss, and L₀ denotes the first latent variable.

The image processing apparatus may reduce the degree of style transfer by using the gradient 1120 that is based on the modified style transfer loss. For example, when a truth value of a pixel of the truth value data 930 is reduced from 1 to 0, the style transfer loss of the pixel may decrease. When the style transfer loss is negatively correlated with the gradient 1120, the gradient 1120 at a specific position may decrease.

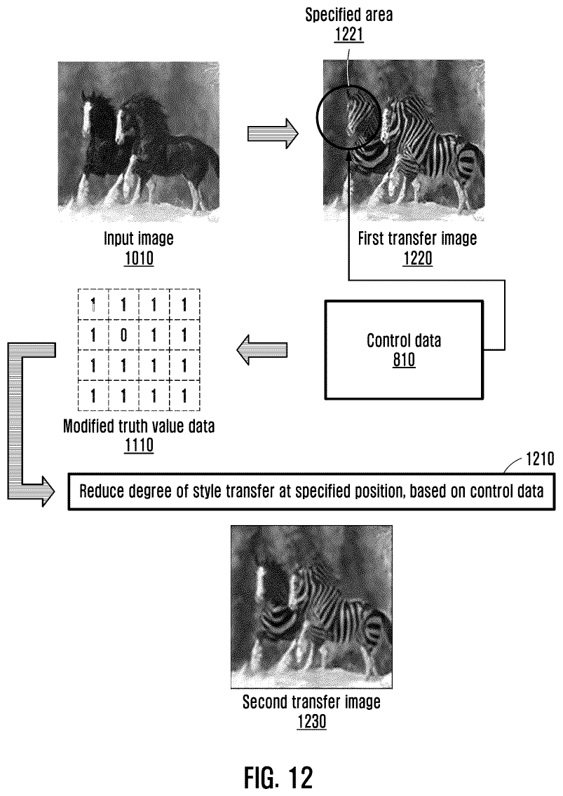

The image processing apparatus may obtain update information from the update information generation model 326, based on the gradient 1120 that has decreased, and may obtain the style transfer image 1130 (e.g., a second transfer image (e.g., the second transfer image 430 of FIG. 4)) by updating the first transfer image, using the obtained update information. An example of obtaining the style transfer image 1130 with a reduced degree of style transfer based on the control data 810, performed by the image processing apparatus, is described in more detail with reference to FIG. 12.

FIG. 12 illustrates an example of a reduction of a degree of image style transfer based on control data.

Referring to FIG. 12, a user may specify a specific area (hereinafter, referred to as a specified area 1221) of a first transfer image 1220 obtained by performing image style transfer on the input image 1010 and may input the control data 810 for reducing a degree of style transfer of the specified area 1221. For example, the user may specify a zebra head position in the first transfer image 1220 and input the control data 810 for reducing the degree of style transfer of the zebra head position.

The image processing apparatus may reduce a style transfer loss by adjusting, based on the control data 810, a truth value of a pixel corresponding to the specified area 1221 of truth value data from 1.0 to 0.0. The image processing apparatus may reduce a gradient, based on the reduced style transfer loss, and may reduce a degree of style transfer of the pixel corresponding to the specified area 1221, based on the reduced gradient.

The image processing apparatus may reduce the degree of style transfer by adjusting the truth value of the pixel corresponding to the specified area 1221 in a map of the truth value data that has been modified based on the control data 810. The image processing apparatus may reduce the truth value of the pixel corresponding to the specified area 1221 of the map of the truth value data 1110, and may reduce style transfer loss based on the reduced truth value. When the style transfer loss is reduced, the gradient may decrease, and the image processing apparatus may reduce the degree of style transfer of the pixel corresponding to the specified area 1221, based on the decreased gradient. The image processing apparatus may obtain a second transfer image 1230 with a reduced degree of style transfer by updating the first transfer image 1220 based on the obtained gradient. An example of the obtaining of the second transfer image 1230 by updating the first transfer image 1220, performed by the image processing apparatus, is described with reference to FIG. 4 and is thus omitted herein.

According to the above-described process, the image processing apparatus may obtain the second transfer image 1230 with a reduced degree of style transfer by performing, based on the control data 810, operation 1210 of reducing a degree of style transfer at a specified position.

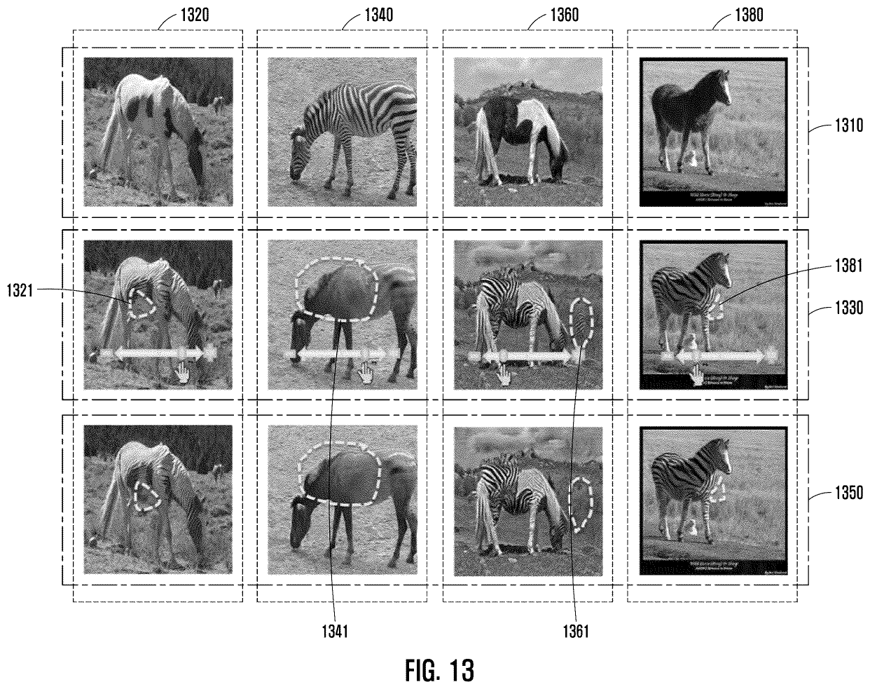

FIG. 13 illustrates an example of image style transfer using control data.

Referring to FIG. 13, the image processing apparatus may transfer input images 1310 into first transfer images 1330, using an image style transformer model. The image processing apparatus may obtain second transfer images 1350 by updating the first transfer images 1330, and may adjust a degree of transfer for a specific area of the first transfer images 1330, based on the control data. An image set (e.g., an image set 1320) may include an input image, a first transfer image, and a second transfer image. A display area of the first transfer image and a display area of the second transfer image corresponding to the first transfer image may represent a same area. For example, a specified area 1321 of the first transfer image included in the image set 1320 may represent a same area as an area that is marked in the second transfer image and that corresponds to the first transfer image.

In the image set 1320 and an image set 1340, the image processing apparatus may enhance a degree of style transfer of a specified area (e.g., the specified area 1321 or a specified area 1341) specified by a user. For example, a slider bar for adjusting the degree of image style transfer may be present at a bottom of each first transfer image included in the first transfer images, and the user may enhance the degree of image transfer by moving the slider bar of a controller to the right.

In an image set 1360 and an image set 1380, the image processing apparatus may reduce a degree of style transfer of a specified area (e.g., a specified area 1361 or a specified area 1381) specified by the user. For example, the user may reduce the degree of image transfer by moving the slider bar of the controller to the left.

The image processing apparatus of one or more embodiments may improve user experience by allowing the user to adjust the degree of image transfer and may transfer specified areas to be more natural. Since an example of adjusting the degree of image transfer is described with reference to FIG. 12, a repeated description thereof is omitted herein.

FIG. 14 illustrates an example of a gradient fusion operation.

An operation of performing image style transfer based on the control data 810 input by the user may be performed in parallel with an operation of performing image style transfer using an image style transfer model (e.g., a generative adversarial neural network).

Referring to FIG. 14, the image processing apparatus may obtain a second transfer image 1440 based on a fused gradient 1433 obtained by fusing a first gradient 1432 and a second gradient 1431. The first gradient 1432 may be a gradient based on first style transfer 1410, and the second gradient 1431 may be a gradient based on the control data 810.

The image processing apparatus may obtain the first gradient 1432 based on transfer quality evaluation data 1420 and may obtain the second gradient 1431 based on the control data 810. The image processing apparatus may obtain a gradient (e.g., the fused gradient 1433) by fusing the first gradient 1432 and the second gradient 1431. Since the image processing apparatus may obtain the first gradient 1432, based on the transfer quality evaluation data 1420 obtained from a discriminator, the first gradient 1432 may be referred to as a “discriminator gradient.” Since the image processing apparatus may obtain the second gradient 1431, based on the control data 810, the second gradient 1431 may be referred to as a “user gradient.”

The image processing apparatus may determine a style transfer loss, based on the transfer quality evaluation data 1420 and truth value data, and may obtain the first gradient 1432, based on the determined style transfer loss. The transfer quality evaluation data 1420 may include reliability of the first transfer image (e.g., the first transfer image 414 of FIG. 4) for the input image 310, and the truth value data may include expected reliability corresponding to each pixel of the first transfer image.

The image processing apparatus may obtain weight data for each of the first gradient 1432 and the second gradient 1431, based on the control data 810, and may obtain the gradient (e.g., the fused gradient 1433) by fusing the first gradient 1432 and the second gradient 1431 based on the weight data.

The image processing apparatus may obtain the second transfer image 1440 from the generator 322, based on the fused gradient 1433, in second style transfer 1430. For example, the image processing apparatus may obtain update information from an update information generation model (e.g., the update information generation model 326 of FIG. 3), based on the fused gradient 1433, and may obtain the second transfer image 1440 by updating, using the obtained update information, the first transfer image.

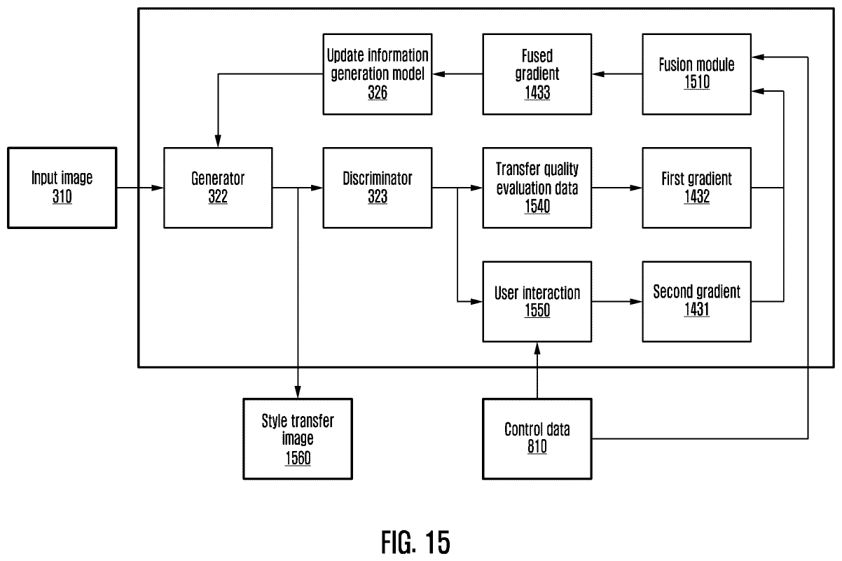

FIG. 15 illustrates an example of generating a style transfer image based on a fusion gradient.

Referring to FIG. 15, an image processing apparatus may obtain a style transfer image 1560 by performing two-step style transfer on the input image 310, based on control data and the fused gradient 1433.

The image processing apparatus (e.g., the image processing apparatus 320 of FIG. 3, the image processing apparatus 1800 of FIG. 18, and/or the image processing apparatus 1900 of FIG. 19) may perform first-step style transfer on the input image 310. In the first-step style transfer, the image processing apparatus may obtain a first transfer image (e.g., the first transfer image 414 of FIG. 4) by performing style transfer on the input image 310. For example, the image processing apparatus may obtain a first latent variable (e.g., the first latent variable 412 of FIG. 4) by encoding, using an encoder of the generator 322 (e.g., the encoder 411 of FIG. 4), the input image 310, and may obtain a first transfer image by decoding, using a decoder of the generator 322 (e.g., the decoder 413 of FIG. 4), the first latent variable.

In the two-step style transfer, the image processing apparatus may obtain the fused gradient 1433 by fusing the first gradient 1432 (e.g., the discriminator gradient of FIG. 14) and the second gradient 1431 (e.g., the user gradient of FIG. 14). The image processing apparatus may obtain the first gradient 1432, based on transfer quality evaluation data 1540, and may obtain the second gradient 1431, based on a user interaction 1550. The user interaction 1550 may be inputting, by the user, of the control data to adjust a degree of image transfer of a specific area of the input image 310. The fused gradient 1433 may be generated through a fusion, by a fusion module 1510, of the first gradient 1432 and the second gradient 1431.

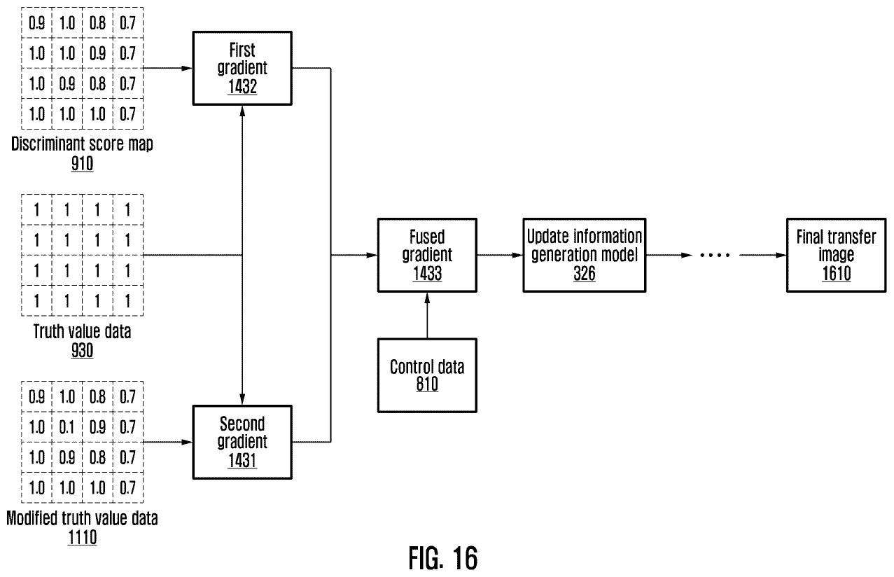

The image processing apparatus may obtain the style transfer image 1560 (e.g., the second transfer image 430 of FIG. 4), based on the fused gradient 1433. For example, the image processing apparatus may obtain update information from the update information generation model 326, based on the fused gradient 1433, and may update the first latent variable, using the update information. The image processing apparatus may obtain a second latent variable (e.g., the second latent variable 423 of FIG. 4) by updating the first latent variable, and may obtain the style transfer image 1560 by decoding, using the decoder of the generator 322, the second latent variable. Since an example of obtaining of the first gradient 1432 and the second gradient 1431 is described with reference to Equations 1 to 4, a repeated description thereof is omitted herein. An example of obtaining of the fused gradient 1433 by fusing the first gradient 1432 and the second gradient 1431 is described in more detail with reference to FIG. 16.

FIG. 16 illustrates an example of a gradient fusion operation.

Referring to FIG. 16, an image processing apparatus may obtain a fused gradient based on a first gradient that is based on a discriminant score map, a second gradient that is based on modified truth value data, and truth value data. The image processing apparatus may obtain update information from an update information generation model, using the fused gradient and control data, and may obtain a final transfer image by updating a first transfer image, based on the obtained update information.

The image processing apparatus may obtain the first gradient, based on the discriminant score map and the truth value data. The image processing apparatus may obtain the second gradient, based on the modified truth value data and the truth value data. The control data may include information for controlling weights of the first gradient and the second gradient, and the image processing apparatus may obtain, from the control data, a weight W_{A} and a weight W_{B} corresponding to the first gradient and the second gradient, respectively.

The weight of the first gradient may correspond to the weight W_{A}, and the weight of the second gradient may correspond to the weight W_{B}. The image processing apparatus may perform gradient fusion by fusing the weights based on Equation 5 below, for example.

$${G}_{C} = {G}_{A} * {W}_{A} + {G}_{B} * {F}_{B} \qquad Equation 5$$

In Equation 5, G_{C} denoted the fused gradient, G_{A} denotes the first gradient, G_{B} denotes the second gradient, W_{A} denotes a weight for adjusting the first gradient, and W_{B} denotes a weight for adjusting the second gradient.

The image processing apparatus may obtain the update information from an update information generation model, using the fused gradient. The image processing apparatus may obtain the final transfer image (e.g., the second transfer image 430 of FIG. 4) by updating the first transfer image, based on mining of the update information.

An image style transfer mode based on weight adjustment may include a first mode, a second mode, and a third mode.

In the case of the first mode: W_{A}≠0, W_{B}=0, a second transfer image may be obtained by updating the first transfer image, using the first gradient.

In the case of the second mode: W_{A}=0, W_{B}≠0, the second transfer image may be obtained by updating the first transfer image, using the second gradient.

In the case of the third mode: W_{A}≠0, W_{B}≠0, the second transfer image may be obtained by updating the first transfer image, using the first gradient and the second gradient.

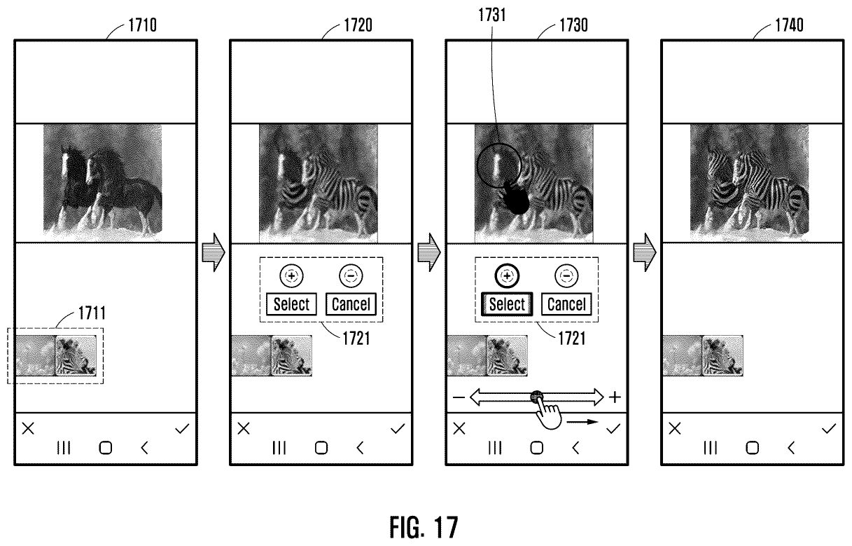

FIG. 17 illustrates an example of image style transfer performed on a mobile terminal.

Referring to FIG. 17, image style transfer may be performed on a mobile terminal. The image style transfer performed on a mobile device may include a plurality of steps (e.g., a step 1710, a step 1720, a step 1730, and a step 1740).

At the step 1710, an input image to be transferred may appear on a display of the mobile device according to a selection of a user. The input image and target styles 1711 may appear on the display of the mobile device. When the user selects one of the target styles 1711, the mobile device may obtain a first transfer image by performing first-step style transfer on the input image. For example, when the input image is an image including a “horse” and the user selects a “zebra style” from among the target styles 1711, the mobile device may obtain the first transfer image including a “zebra,” by performing first-step style transfer on the “horse” of the input image.

At the step 1720, the first transfer image may appear on the display of the mobile device. The first transfer image and a selection window 1721 for selecting or cancelling an area of the first transfer image may appear together on the display of the mobile device.

At the step 1730, when control data based on a manipulation of a slider bar 1732 by the user is input to the mobile device, the mobile device may obtain a gradient that is based on the control data and transfer quality evaluation data. The mobile device may obtain update information, using the gradient and an update information generation model, and may obtain a second transfer image by updating the first transfer image, based on the obtained update information. For example, the user may specify an area (hereinafter, referred to as a specified area 1731) of the first transfer image to be adjusted. The user may specify a zebra face area of the first transfer image as the specified area 1731. When the user selects “Select” in the selection window 1721, the user may manipulate the slider bar 1732 for adjusting a degree of image transfer of the specified area 1731. The user may adjust the degree of style transfer of the first transfer image by moving the slider bar 1732 to the right or left. For example, the user may enhance the degree of image transfer of the specified area 1731 by moving the slider bar 1732 to the right. The term “move” may be replaced with, but is not limited to, “swipe” or “drag.”

At the step 1740, the mobile device may display, on the display, the second transfer image in which the degree of image transfer of the specified area 1731 may be enhanced by performing of second-step transfer. The mobile device may enhance style transfer of the specified area 1731 by enhancing the degree of style transfer, obtain a more realistic and natural image by reducing an artificially generated trace, and display the obtained second transfer image on the display.

FIG. 18 illustrates a block diagram of an example of an image processing apparatus.

An image processing apparatus 1800 may include a memory 1810 (e.g., one or more memories) and a processor 1820 (e.g., one or more processors).

The memory 1810 may store instructions executable by the processor 1820. The memory 1810 may store instructions executable by the processor 1820. The instructions executable by the processor 1820 may, when executed by the processor 1820, cause the processor 1820 to perform an image processing method or a training method of a transformer model. The memory 1810 may be integrated with the processor 1820. For example, the memory 1810 may be or include random-access memory (RAM) and/or flash memory arranged in an integrated circuit microprocessor or the like. In addition, the memory 1810 may include a separate device, such as an external disk drive, a storage array, and/or other storage devices that may be used by a database system. The memory 1810 and the processor 1820 may be operatively integrated and/or may communicate with each other through an input/output (I/O) port and/or a network connection such that the processor 1820 may read a file stored in the memory 1810. The memory 1810 may be a computer-readable storage medium storing instructions, and the instructions stored in the memory 1810 may, when executed by the processor 1820, prompt at least one processor 1820 to execute the image processing method or a training method of an image processing model. For example, the memory 1810 may be or include a non-transitory computer-readable storage medium storing instructions that, when executed by the processor 1820, configure the processor 1820 to perform any one, any combination, or all of the operations and methods disclosed herein with reference to FIGS. 1-17.

Examples of a non-transitory computer-readable storage medium included in the memory 1810 may include read-only memory (ROM), random-access programmable read-only memory (PROM), electrically erasable programmable read-only memory (EEPROM), RAM, dynamic RAM (DRAM), static RAM (SRAM), flash memory, a nonvolatile memory, CD-ROM, a CD-R, a CD+R, a CD-RW, a CD+RW, DVD-ROM, a DVD-R, a DVD+R, a DVD-RW, a DVD+RW, DVD-RAM, BD-ROM, a BD-R, a BD-R LTH, a BD-RE, a BLU-RAY and/or optical disk memory, a hard disk drive (HDD), a solid state drive (SSD), a card memory (e.g., a multimedia card, a secure digital (SD) card, and/or an extreme digital (XD) card), magnetic tape, a floppy disk, a magneto-optical data storage device, an optical data storage device, a hard disk, a solid-state disk, and/or other devices.

For example, the processor 1820 may execute instructions stored in the memory 1810. The processor 1820 may include a central processing unit (CPU), a graphics processing unit (GPU), a neural network processing unit (NPU), a media processing unit (MPU), a data processing unit (DPU), a vision processing unit (VPU), a video processor, an image processor, a display processor, a microprocessor, a processor core, a multi-core processor, an application-specific integrated circuit (ASIC), a field programmable gate array (FPGA), and/or any combination thereof.

The processor 1820 may obtain a first transfer image (e.g., the first transfer image 414 of FIG. 4) corresponding to an input image by performing style transfer on the input image (e.g., the input image 310 of FIG. 3), using an image style transformer model (e.g., the image style transformer model 321 of FIG. 3), may obtain transfer quality evaluation data (e.g., the transfer quality evaluation data 324 of FIG. 3) for the first transfer image, using the image style transformer model, may obtain the gradient (e.g., the gradient 325 of FIG. 3) for the style transfer loss, based on the transfer quality evaluation data, may obtain update information on the first transfer image from an update information generation model to which the gradient is input, and may obtain the second transfer image (e.g., the second transfer image 430 of FIG. 4) by updating, based on the update information, the first transfer image. The processor 1820 may obtain the control data including information on image style transfer, and may obtain the gradient, based on the transfer quality evaluation data and the control data.

The processor 1820 may obtain a first latent variable (e.g., the first latent variable 412 of FIG. 4) by encoding, using an image style transformer model, an input image, obtain a first transfer image by decoding, using the image style transformer model, the first latent variable, obtain a second latent variable (e.g., the second latent variable 423 of FIG. 4) by updating the first latent variable, based on update information, and obtain a second transfer image by decoding, using the image style transformer model, the second latent variable.

Transfer quality evaluation data (e.g., the transfer quality evaluation data 324 of FIG. 3) may include reliability of a first transfer image for an input image, and truth value data (e.g., the truth value data 930 of FIG. 9) may include expected reliability for each pixel of the first transfer image. The processor 1820 may determine a style transfer loss, based on the transfer quality evaluation data and the truth value data, and may obtain a gradient, based on the determined style transfer loss.

The processor 1820 may obtain the first transfer image corresponding to the input image by performing style transfer on the input image, using an image style transformer model, obtain control data including image style transfer information, obtain the gradient for style transfer loss, based on the control data, and obtain the second transfer image by updating the first transfer image, based on the gradient. The processor 1820 may adjust the style transfer loss, based on the control data, and may obtain the gradient, based on the adjusted style transfer loss. The image style transformer model may be a generative adversarial neural network, and the processor 1820 may obtain the transfer quality evaluation data of the first transfer image, using the generative adversarial neural network, and may obtain the gradient, based on the transfer quality evaluation data and the control data. The processor 1820 may obtain a first gradient (e.g., the first gradient 1432 of FIG. 14), based on the transfer quality evaluation data, obtain a second gradient (e.g., the second gradient 1431 of FIG. 14), based on the control data, and obtain a gradient (e.g., the fused gradient 1433 of FIG. 14) by fusing the first gradient and the second gradient. The processor 1820 may adjust the style transfer loss, based on the control data, and may obtain the second gradient, based on the adjusted style transfer loss. The processor 1820 may adjust at least one of the transfer quality evaluation data and the truth value data, based on the control data, and may adjust the style transfer loss, based on the adjusted transfer quality evaluation data and the modified truth value data (e.g., the modified truth value data 1110 of FIG. 16). The processor 1820 may adjust reliability data corresponding to at least one of pixels of the first transfer image, based on the control data, and may adjust the truth value data corresponding to at least one of the pixels of the first transfer image, based on the control data. The processor 1820 may obtain weight data for each of the first gradient and the second gradient, based on the control data, and may obtain the gradient by fusing the first gradient and the second gradient based on the weight data. The processor 1820 may obtain the update information on the first transfer image from the update information generation model to which the gradient is input, and may obtain the second transfer image by updating, based on the update information, the first transfer image. The image style transfer model may be a generative adversarial neural network, and the processor 1820 may obtain the first latent variable by encoding the input image, using the image style transformer model, may obtain the first transfer image by decoding the first latent variable, using the image style transformer model, may obtain the second latent variable by updating the first latent variable, based on the update information, and may obtain the second transfer image by decoding the second latent variable, using the image style transformer model.

FIG. 19 illustrates a block diagram of an example of components of an image processing apparatus.

An image processing apparatus 1900 may include the processor 1820, the memory 1810, a transceiver 1910, and a bus 1930. The processor 1820, the memory 1810, and the transceiver 1910 may be connected to each other by the bus 1930. Since an example of the processor 1820 is described with reference to FIG. 18, a repeated description thereof is omitted herein.

Since an example of the memory 1810 is described with reference to FIG. 18, a repeated description thereof is omitted herein. The memory 1810 may store a computer program 1920 or executable instructions and may be controlled by the processor 1820. The computer program 1920 stored in the memory 1810 may be executed by the memory 1810. For example, the computer program 1920 stored in the memory 1810 may be executed by the processor 1820 for image processing.

The transceiver 1910 may transmit or receive data between the image processing device 1900 and another electronic device. The transceiver 1910 may support establishment of a direct (e.g., wired) communication channel or a wireless communication channel between the image processing device 1900 and an external electronic device and may support performance of communication through the established communication channel. The transceiver 1910 may include a communication processor that operates independently of the processor 1820 (e.g., an application processor) and supports direct (e.g., wired) or wireless communication.

The bus 1930 may be a path for transferring information between the processor 1820, the memory 1810, and the transceiver 1910, and may be provided in plurality. The bus 1930 may be a peripheral component interconnect (PCI) bus or an extended industry standard architecture (EISA) bus. The bus 1930 may include an address bus, a data bus, a control bus, and the like.

The image processing apparatuses, generators, discriminators, encoders, decoders, memories, processors, transceivers, buses, image processing apparatus 320, generator 322, discriminator 323, encoder 411, decoder 413, image processing apparatus 1800, memory 1810, processor 1820, image processing apparatus 1900, transceiver 1910, and bus 1930 described herein, including descriptions with respect to respect to FIGS. 1-19, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-19 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An apparatus with image processing, the apparatus comprising:
one or more processors configured to:
generate a first transfer image corresponding to an input image by performing style transfer on the input image, using an image style transformer model;
obtain transfer quality evaluation data on the first transfer image, using the image style transformer model;
obtain a gradient for a style transfer loss, based on the transfer quality evaluation data;
obtain update information on the first transfer image from an update information generation model to which the gradient is input; and
generate a second transfer image by updating the first transfer image, based on the update information.

2. The apparatus of claim 1, wherein, for the obtaining of the gradient, the one or more processors are configured to:
obtain control data comprising image style transfer information; and
obtain the gradient, based on the transfer quality evaluation data and the control data.

3. The apparatus of claim 1, wherein the one or more processors are configured to:
obtain a first latent variable by encoding the input image, using the image style transformer model;
for the generating of the first transfer image, generate the first transfer image by decoding the first latent variable, using the image style transformer model;
obtaining a second latent variable by updating the first latent variable, based on the update information; and
for the generating of the second transfer image, generate the second transfer image by decoding the second latent variable, using the image style transformer model.

4. The apparatus of claim 1, wherein
the transfer quality evaluation data comprises reliability of the first transfer image for the input image,
for the obtaining of the gradient, the one or more processors are configured to:
determine a style transfer loss, based on the transfer quality evaluation data and truth value data; and
obtain the gradient, based on the determined style transfer loss, and
the truth value data comprises expected reliability for each pixel of the first transfer image.

5. The apparatus of claim 2, wherein the control data comprises any one or any combination of any two or more of a direction of the style transfer, a degree of the style transfer, and a position of the style transfer.

6. The apparatus of claim 2, wherein, for the obtaining of the gradient, the one or more processors are configured to:
obtain a first gradient, based on the transfer quality evaluation data;
obtain a second gradient, based on the control data; and
obtain the gradient by fusing the first gradient and the second gradient.

7. The apparatus of claim 6, wherein
the transfer quality evaluation data comprises reliability data of the first transfer image for the input image,
for the obtaining of the first gradient, the one or more processors are configured to:
determine the style transfer loss, based on the transfer quality evaluation data and truth value data; and
obtain the first gradient based on the determined style transfer loss, and
the truth value data comprises expected reliability data for each pixel of the first transfer image.

8. The apparatus of claim 7, wherein, for the obtaining of the second gradient, the one or more processors are configured to:
adjust the style transfer loss, based on the control data; and
obtain the second gradient, based on the adjusted style transfer loss.

9. The apparatus of claim 8, wherein, for adjusting of the style transfer loss, the one or more processors are configured to:
adjust either one or both of the transfer quality evaluation data and the truth value data, based on the control data; and
adjust the style transfer loss, based on the adjusted transfer quality evaluation data and the modified truth value data.

10. The apparatus of claim 9, wherein, for the adjusting of the either one or both of the transfer quality evaluation data and the truth value data, the one or more processors are configured to:
adjust the reliability data corresponding to one or more of pixels of the first transfer image, based on the control data; and
adjust the truth value data corresponding to one or more of the pixels of the first transfer image, based on the control data.

11. The apparatus of claim 6, wherein, for the obtaining of the gradient by fusing the first gradient and the second gradient, the one or more processors are configured to:
obtain weight data for each of the first gradient and the second gradient, based on the control data; and
obtain the gradient by fusing the first gradient and the second gradient, based on the weight data.

12. An apparatus with image processing, the apparatus comprising:
one or more processors configured to:
generate a first transfer image corresponding to an input image by performing style transfer on the input image, using an image style transformer model;
obtain control data comprising image style transfer information;
obtain a gradient for a style transfer loss, based on the control data; and
generate a second transfer image by updating the first transfer image, based on the gradient.

13. The apparatus of claim 12, wherein, for the obtaining of the gradient, the one or more processors are configured to:
adjust the style transfer loss, based on the control data; and
obtain the gradient, based on the adjusted style transfer loss.

14. The apparatus of claim 12, wherein
the image style transformer model is a generative adversarial neural network, and
for the obtaining of the gradient, the one or more processors are configured to:
obtain transfer quality evaluation data of the first transfer image, using the generative adversarial neural network; and
obtain the gradient, based on the transfer quality evaluation data and the control data.

15. The apparatus of claim 12, wherein, for the generating of the second transfer image, the one or more processors are configured to:
obtain update information on the first transfer image from an update information generation model to which the gradient is input; and
generate the second transfer image by updating the first transfer image, based on the update information.

16. The apparatus of claim 15, wherein
the image style transformer model is a generative adversarial neural network, and
the one or more processors are configured to:
obtain a first latent variable by encoding the input image, using the image style transformer model;
for the generating of the first transfer image, generate the first transfer image by decoding the first latent variable, using the image style transformer model;
obtain a second latent variable by updating the first latent variable, based on the update information; and
for the generating of the second transfer image, generate the second transfer image by decoding the second latent variable, using the image style transformer model.

17. A processor-implemented method with image processing, the method comprising:
generating a first transfer image corresponding to an input image by performing style transfer on the input image, using an image style transformer model;
obtaining transfer quality evaluation data for the first transfer image, using the image style transformer model;
obtaining a gradient for a style transfer loss, based on the transfer quality evaluation data;
obtaining update information on the first transfer image from an update information generation model to which the gradient is input; and
generating a second transfer image by updating the first transfer image, based on the update information.

18. The method of claim 17, further comprising:
obtaining control data comprising image style transfer information,
wherein the obtaining of the gradient comprises obtaining the gradient, based on the transfer quality evaluation data and the control data.

19. The method of claim 17, wherein
the generating of the first transfer image comprises:
obtaining a first latent variable by encoding the input image, using the image style transformer model; and
generating a first transfer image by decoding the first latent variable, using the image style transformer model, and
the generating of the second transfer image comprises:
obtaining a second latent variable by updating the first latent variable, based on the update information; and
generating the second transfer image by decoding the second latent variable, using the image style transformer model.
